(19) United States
(12) Patent Application Publication
(10) Pub. No.: US 2023/0141107 A1
(43) Pub. Date: May 11, 2023

(54) MIXED SALINITY IMPACT ON INTERPRETATION AND REMEDIAL DETECTION TECHNIQUE

(71) Applicant: Baker Hughes Oilfield Operations LLC, Houston, TX (US)

(72) Inventors: Sandip Maity, Manama (BH); Mohamed A. El Sharaky, Dubai (AE)

(73) Assignee: Baker Hughes Oilfield Operations LLC, Houston, TX (US)

(21) Appl. No.: 17/913,188

(22) PCT Filed: Jun. 17, 2020
(86) PCT No.: PCT/US2020/038107

§ 371 Date: Sep. 21, 2022

(30) Foreign Application Priority Data
Mar. 24, 2020 (GC) 2020-39425

(51) Int. Cl. G01N 21/68; G01N 21/85; G01N 21/69; E21B 49/08; E21B 21/08

(52) U.S. Cl. CPC G01N 21/68; G01N 21/85; G01N 21/69; E21B 49/08; E21B 21/08; G01N 2021/8557

(57) ABSTRACT

The present disclosure is for a tool and a method using or making the tool for detection of production or formation water in drilling fluid. The tool includes a sampling chamber to receive a bypass line from a flow line at a well site. The tool further includes spectroscopy components to perform spectroscopy of the drilling fluid bypassed from a flow line into the bypass line. Processing components are provided in the tool to process spectra from the spectroscopy of the drilling fluid and to generate data associated with at least identification formation or production water in the drilling fluid. The tool includes a communication module to transmit the data externally from the tool.

### CROSS REFERENCE TO RELATED APPLICATIONS

This Application is a National Stage application of PCT Application No. PCT/US2020/038107, filed Jun. 17, 2020, titled “MIXED SALINITY IMPACT ON INTERPRETATION AND REMEDIAL DETECTION TECHNIQUE,” which claims the benefit of priority from Gulf Cooperation Council (GCC) Application Number 2020-39425, filed Mar. 24, 2020, titled “MIXED SALINITY IMPACT ON INTERPRETATION AND REMEDIAL DETECTION TECHNIQUE,” the entire disclosures of which are incorporated by reference herein for all intents and purposes.

### BACKGROUND

### 1. Field of Invention

This invention relates in general to equipment used in the hydrocarbon industry, and in particular, to a tool for detection or differentiation of formation or production water from drilling fluid by analysis of at least mixed salinity in drilling fluid from a drill site during a drilling operation or during a production logging operation.

### 2. Description of the Prior Art

A feature in oil and gas production is to maximize economic value from available reservoirs. This enables an operator to make informed decisions on development and production of a well at a drill site based in part on analysis of fluid from a downhole environment. In an example, long transition zones may exist in the downhole environment. The long transition zones may include low quality rocks of low mobility (e.g., in carbonates) and are encountered during drilling or production logging operations. As a result, production of formation water and formation oil is expected but may be apparent in the long transition zones. The ability to distinguish formation water from applied fluid in the drilling fluid thus bears pertinence. For instance, drilling fluid from a drilling operation may include applied fluid (e.g., one or more of water-based mud, applied water, and some applied oils) as well as downhole fluid (e.g., formation or production water and well oil) from the downhole environment. The content of the formation or production water in the downhole fluid may determine the productivity of the well. For instance, determination of an amount of the formation or production water may be used to calculate well oil content from the drilling fluid and may be extrapolated to determine oil production/reserve capacity of the well.

Further, existing equipment for determining the content of the drilling fluid may require the use of laboratories external to the drill site, may require time to communicate collected samples from the drill site, and may include other inconveniences. For instance, formation or production water and water-based mud may have a similar salinity that may result in improper content analysis of the downhole fluid using formation testers with current sensors. In such instances, the formation testers will be unable to affirmatively differentiate the composition components of the drilling fluid and may require more pumping time and added costs to ensure that production capacity is worthwhile of the drilling operations and is worthwhile to continue ongoing production logging operations. In addition, the drilling may pass through the referenced long transition zones that may include formation water and oil; and collecting samples at appropriate times may pose a challenge.

### SUMMARY

A tool is disclosed for detection of at least formation or production water in drilling fluid. The tool includes a sampling chamber to receive a bypass line from a flow line at a well site. The tool further includes spectroscopy components to perform spectroscopy of the drilling fluid bypassed from a flow line into the bypass line. Processing components are provided in the tool to process spectra from the spectroscopy of the drilling fluid and to generate data associated with formation or production water composition components of the spectra. The tool includes a communication module to transmit the data externally from the tool.

A method is also disclosed for detection of at least formation or production water from drilling fluid. The method includes enabling a sampling chamber to receive drilling fluid from a bypass line of a flow line at a well site. A further sub-process of the method performs spectroscopy of the drilling fluid using a spectrometer to generate spectra. Another sub-process enables processing of the spectra to generate data associated with formation or production water composition components of the spectra. A sub-process of the method enables communication of the data to a receiver located externally from the downhole environment.

### BRIEF DESCRIPTION OF THE DRAWINGS

Various embodiments in accordance with the present disclosure will be described with reference to the drawings, in which:

FIG. 1 illustrates an example adaptation of a tool for detection of formation or production water, in accordance with various embodiments.

FIG. 1B illustrates an example block of components within a tool for detection of formation or production water, in accordance with various embodiments.

FIG. 2 illustrates a graphical representation of spectra from drilling fluid sampled by a tool for detection of formation or production water, in accordance with various embodiments.

FIG. 3 illustrates a graphical representation of spectra colors from data associated with spectra of a drilling fluid sampled by a tool for detection of formation or production water, in accordance with various embodiments.

FIG. 4 illustrates example sub-processes in a process flow for detection of formation or production water, in accordance with various embodiments.

FIG. 5 illustrates example sub-processes in a process flow for detection of formation or production water, in accordance with various embodiments.

FIG. 6 illustrates an example process flow for detection of formation or production water, in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Various other functions can be implemented within the various embodiments as well as discussed and suggested elsewhere herein. In at least an aspect, the present tool for detection of formation or production water in an in-situ tool that is able to perform analysis of at least mixed salinity in fluid from a drill site during a drilling operation.

In at least one aspect, the present tool is an in-situ tool that works in the downhole environment. The present tool identifies water when it is in a small percentage in the drilling fluid and enables confident reporting of applied water (referred to also as injection water) versus formation or production water during sampling of the drilling fluid in a two-mud system. For instance, composition components are different salinities and identifying elements based in part on the salinities enables the detection, differentiation, and measurement of formation water during drilling or production logging. The present tool may be used in transition zones where multiphase flow is expected or in the case of close salinities of water-based mud and formation or production water. The close salinities occur because of similar composition components in the drilling fluid that may be distinguished by an analysis performed on the drilling fluid during the operation—whether drilling or production logging. In a further example, the present tool identifies formation or production water during drilling operations or during production logging operations. Further, as the present tool is an in-situ detection tool, it is possible to perform detection requirements in transition zones (e.g., in between formation water and oil flowing zones) of the downhole environment. The detection also enables content determination so that high oil cut values are determined prior to production. With the in-situ capabilities described herein, the tool of the present disclosure can be moved quickly in the wellsite to map and to track the applied water that is mixed with other composition components of the drilling fluid. Information about the location of oil versus the location of water informs an operator of where to begin production and the oil concentration level capable of being drilled well in advance of the production cycle.

In at least one aspect, setting aside any applied fluid, knowledge of the concentration of formation or production water in the downhole fluid is an indication of the amount of oil that can be generated from a well as the formation or production water from the downhole fluid may remain constant through the life of the well. Further, this knowledge is also helpful to consider costs and complexity required to ensure oil extraction from the downhole fluid by removal of the formation or production water, which is usually an expensive proposition. Furthermore, in case of the transition zone where well oil (also referred to as formation oil) and formation water are both flowing, this information may be used to determine formation water for reserved estimation and for oil cut production. For instance, determination that the drilling fluid is 70% formation oil and 30% formation water means that the well is producing formation oil at a 70% production limit for any produced downhole fluid. However, a determination that the drilling fluid is 70% formation oil and 30% water-based mud would imply that well or formation oil is 100% of the downhole fluid as the water-based mud is an applied fluid that can be removed relatively easily from the drilling fluid than the formation or production water.

In at least one aspect, to allow identification of production or formation water in the drilling fluid, the present tool is able to determine presence of one or more of strontium and beryllium in the drilling fluid. In at least one aspect, determination that the drilling fluid is 30% formation water and 20% applied water would imply that the well is producing formation oil at a 70% production limit for any produced downhole fluid as the applied water may be easily removed but the formation water remains part of the well oil. However, a determination that the drilling fluid is 20% applied water (e.g., part of water-based mud) with no formation or production water detected would imply that 100% of the downhole fluid is well or formation oil as the applied water or water-based mud an applied fluid that can be removed relatively easily from the drilling fluid than the formation or production water. In at least one aspect, determination or identification of a water cut during operations, and further, determination or identification of a type of water, e.g., water-based mud or formation water, in a transition zone provides impact to a determination of productivity of a well. This information is also useful to determine hydrocarbon reserves or estimations. Still further, the present tool addresses an added complexity of when the salinity of the water-based mud is close to the expected salinity of the formation water, by at least the use of spectroscopy to detect composition compounds of formation or production water, for instance.

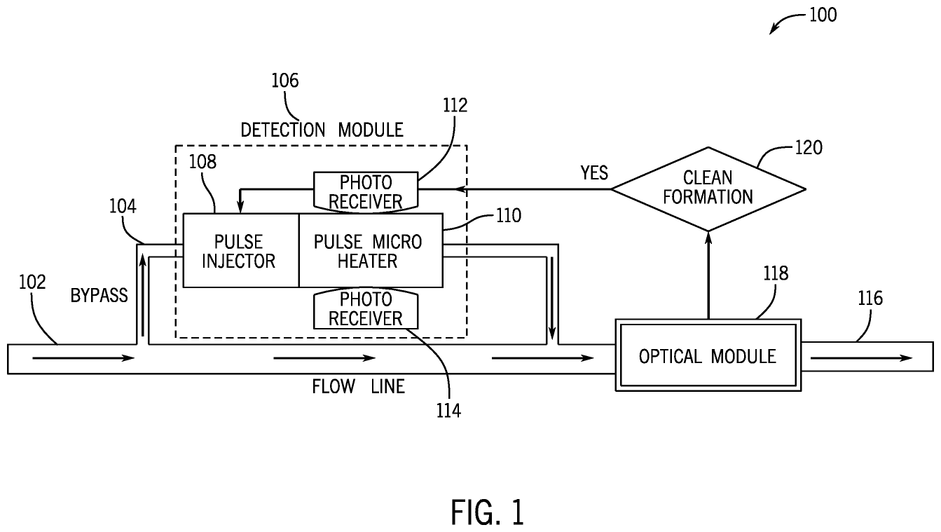

FIG. 1 illustrates an example adaptation 100 of a tool 106 for detection of formation or production water, in accordance with various embodiments. Flow line 102 may be fitted with a bypass line 104. In at least one aspect, the flow line is a pipe in a downhole environment that supports a drill or a downhole tool. In at least one aspect, the flow line in sent as part of the drill to follow a drill bit inside the downhole environment. The flow line may also include the applied fluid (e.g., one or more of water-based mud, water, and some applied oils) to support drilling operations at a well. The bypass line 102 couples to a detection module 106 for performing one or all aspects of detection and differentiation of, as well at least an aspect of measurement of, formation or production water, in accordance with various embodiments.

In at least one aspect, a pulse micro heater 110 and photo receivers 112, 114 are part of the tool. The tool, however, may be part of a system for detection of formation or production water, may be associated with an optical module 118 for detection of contaminants or impurities in the drilling fluid. As applied fluid and downhole fluid may be present at the same time, the optical module may be used to trigger the detection module 106 to perform the detection of formation or production water. In at least one aspect, the triggering may be by a mechanical, electrical, hydraulic, or pneumatic switch associated with the decision feature 120. In an example, as illustrated in the example of FIG. 1B a valve may be trigger to turn to open position to allow sampling of the drilling fluid in the flow line 102 through the bypass line 104. In an aspect, the trigger only activates when water (without impurities) is detected via the optical module 118. The water may be the applied water and may include formation or production water.

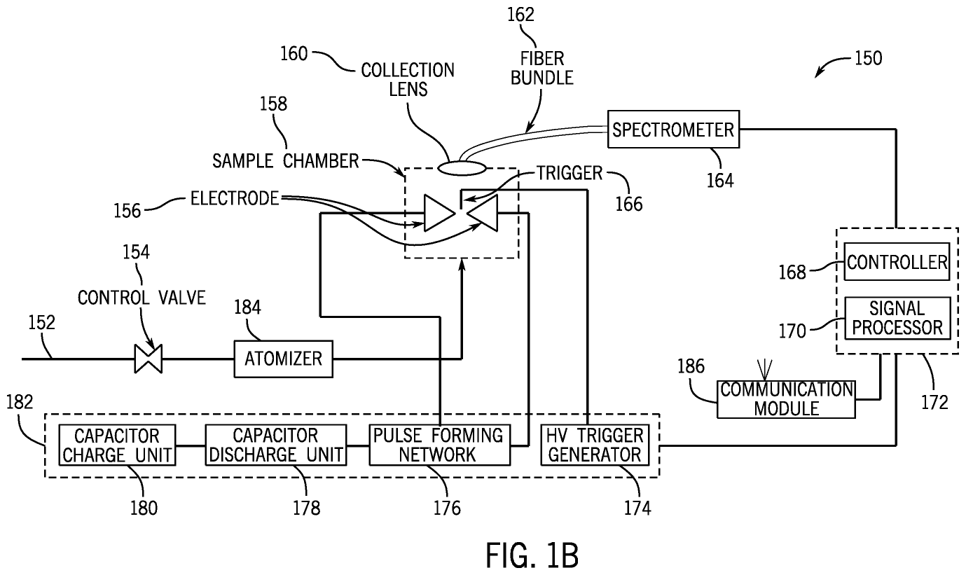

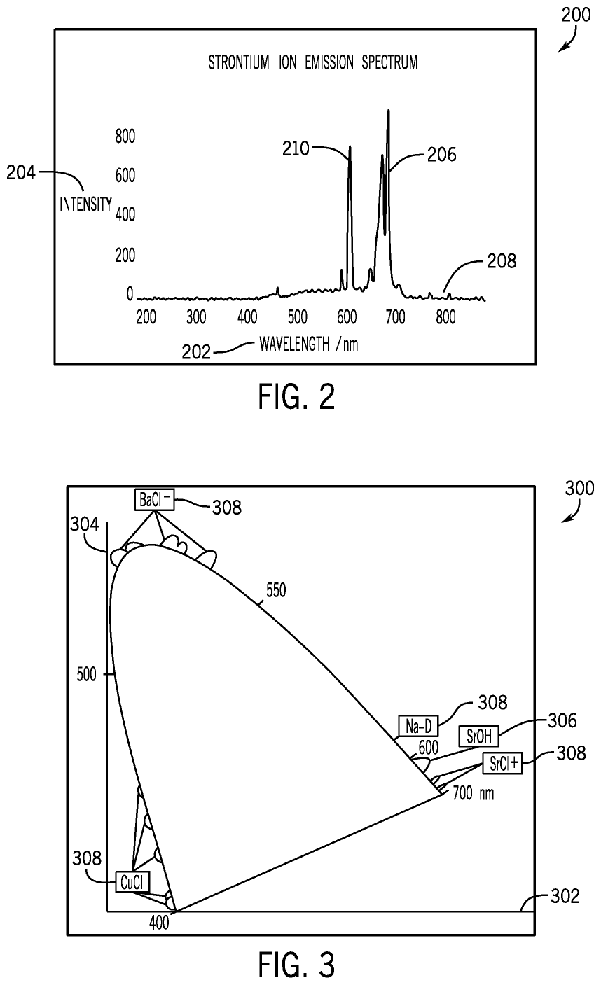

In at least one aspect, the optical module 118 uses fluorescence to determine the impurities in the drilling fluid. In at least one aspect, instead of determination of impurities or contaminants, a determination of water, whether applied water or formation water, may be made by the optical module to initiate detection of the formation water by the detection module 106. In at least one aspect, when the optical module 118 is adapted to determine the impurities, which may include unwanted components forming more than a predetermined content percentage of a volume of drilling fluid. The unwanted components are not one or more of: formation or production water, water-based mud, applied water, some applied oils, and well oil. When the unwanted components are more than the predetermined content percentage, then the detection module will not be allowed to perform its detection tasks. Examples of the unwanted components are discussed with respect to FIGS. 2, 3.

In at least one aspect, once an acceptable amount of contaminants is determined to exist (or if the contaminants are determined to be fully absent) then the drilling fluid (including the applied water and the formation water) may be passed into the bypass line 104. In at least one aspect, the pulse injector 108 may use laser or other wavelengths of light having one or more energy levels to excite components of the drilling fluid sampled during a detection phase in the detection module 106. The pulse injector 108 may be a type of electron gun providing a focused beam that is used to enable the plasma. A pulse micro heater 110 is provided for pulse heating of the drilling fluid at a nano-liter volume quantity. The plasma enables spectral analysis of the sample drilling fluid that is pulse heated and atomized in the present tool. Photo receivers 112, 114 are provided to sense the spectra received once the sample drilling fluid is exposed to the plasma. Further components within each of the modules 108, 110 is explained with respect to FIG. 1A.

FIG. 1B illustrates an example block 150 of components 156-186 within or associated with a tool for detection of formation or production water, in accordance with various embodiments. The bypass line of FIG. 1A is illustrated in FIG. 1B as bypass line 152 having an associated control valve 154 why may be triggered when an optical module (such as illustrated in FIG. 1A) determines that the drilling fluid is free (or has decreased) impurities. The drilling fluid is sampled through the bypass line 152 and provided to atomizer 184 to provide discrete or continuous atomized drilling fluid within a sample chamber 158. Electrodes 156 associated with the sample chamber 158 are charged via a pulse forming network unit 176 to provide plasma for a spectral analysis of the atomized drilling fluid. In at least one aspect, a capacitor charge unit 180 is coupled with a capacitor discharge unit 178 to provide appropriate pulse form to achieve intended plasma levels.

In at least one aspect, pulse forming network unit 176 is adapted to convert direct current (DC) or alternating current (AC) to single direction pulses. In at least one aspect, the pulses are high energy level pulses for short duration, such as to achieve a stable plasma region for 2-3 seconds. The high energy level pulse provides a corona discharge in the stable plasma region. In at least one aspect, capacitor charging is provided by a capacitor charge unit 180. A capacitor of the capacitor charging unit 180 is charged till a breakdown value is obtained. The capacitor discharges from the breakdown value (and from the time since the breakdown value). The capacitor begins to discharge, via capacitor discharge unit 178, through the pulse forming network 175, and the gap between the electrodes 156 to cause electrical breakdown in the gap. The gap between the electrodes 156 may be in a resistive phase so that plasma resistance is proportional to a time or length of discharge. At the desired stable plasma region, the discharge is made steady so that the resistance in the gap is at a minimum value. The electric breakdown in the gap contributes to the plasma developed in the region for spectral analysis of an applied drilling fluid sample, such as the atomized drilling fluid sprayed within the same chamber 158.

In addition, to initiate the plasma, a high voltage trigger generator 174 is provided to create a high voltage pulse that ionizes the media in the gap between the electrodes 156. This ionization enables the capacitor discharge unit 178 and the pulse forming network 176 to provide a further voltage discharge between the gap resulting in the plasma for the spectral analysis of the atomized drilling fluid in the sample chamber 158. In at least one aspect, plasma generation components 174-180 may be part of a plasma discharge module 182, which may be part of the pulse injector 108 and/or the pulse micro heater 110 components of the tool 106.

Collection lens 160 is provided to collect sample spectra from the sample chamber 158 of the atomized drilling fluid. The sample spectra is fed to a spectrometer 164 associated with the sampling chamber 158. Such association may be by a fiber bundle 162 to transmit the sample spectra to the spectrometer 164. The sample spectra may be converted to independent values of intensity (in counts, for instance) and wavelength (in nanometers, for instance) forming readouts or transformation values output by the spectrometer. A processing circuit 172 having processing components such as a controller (e.g., microprocessor) 168 may be provided to work with a signal processor 170 to further correlate the independent values from the sample spectra to determined ranges or values of components that can define the contents of the drilling fluid. For instance, the correlation may be by processing signals having the independent values from the spectrometer to determine or identify discriminant nature of the signals—for instance, to separate components of the signals corresponding to different materials within the drilling fluid, as illustrated by the component graphs in FIGS. 2 and 3. In at least one aspect, the features of the spectrometer 164 may be combined with the circuit 172, and particularly with controller 168 and signal processor 170, to generate the correlation as data for transmission external to the tool (e.g., to the surface relative to the downhole environment). The tool for detection of the present disclosure includes a communication module 186 to perform the transmission of the data, from the correlation performed by the controller and/or the signal processor, or from the independent values of the spectrometer, to a module external to the tool. In an instance, the module external to the tool is at ground level at the well site or external to the well site. As such, the tool is in the downhole environment but can provide in-situ analysis of the drilling fluid to enable detection of formation or production water, instantaneously as drilling progresses, to operators outside the downhole environment.

FIG. 2 illustrates a graphical representation 200 of spectra from drilling fluid sampled by a tool for detection of formation or production water, in accordance with various embodiments. In an example, underlying values of the graphical representation 200 may be an output of the spectrometer 164 and may be a continuous readout or transformation of raw spectra collected by the collective lens 160. The graphical representation 200 illustrates that the readout or transformation from raw spectra may be provided in a two dimensional scale with intensity 204 on one axis and wavelength 202 on the other axis. The spikes 206, 210 are illustrated as indicative of presence of strontium ion in the drilling fluid. Strontium ion is understood to be the highest composition component of formation or production water. With the readout or transformation from raw spectra, as represented in the graphical representation 200, it is possible to determine an amount of the formation or production water relative to other insignificant composition components 208. For instance, for a given volume of the atomized drilling fluid, the intensity of the components 206, 208, 210 may be correlated to each other and the given volume as percentage composition components. The correlation may be extrapolated to the volume within the flow line 102 to determine the content of formation or production water and of well oil in the downhole environment. In an example, the controller may be provided with instantaneous volume in the flow line 102 and may be adapted to perform the extrapolation in real time. In at least one aspect, the detection process may be repeated at different times to provide instantaneous readouts or transformations at the different times, and to additionally provide instantaneous composition component analysis extrapolated therefrom for the current volume of drilling fluid at the different times. In at least one aspect, the detection process may be repeated at different depths to provide instantaneous readouts or transformations at the different depths, and to additionally provide instantaneous composition component analysis extrapolated therefrom for the current volume of drilling fluid at the different depths.

FIG. 3 a graphical representation 300 of spectra identifying composition components 306, 308 from data associated with spectra of a drilling fluid sampled by a tool for detection of formation or production water, in accordance with various embodiments. In an example, underlying values of the graphical representation 300 may be an output of the controller 168 using the output of the spectrometer 164, which may be the continuous readout or transformation of FIG. 2. In at least one aspect, the spectrometer may provide sufficient underlying values to generate graphical representation 300 without further processing. FIG. 3 illustrates the various composition components 306, 308 found in a spectral analysis of the drilling fluid. The composition components may include BaCl₂ (barium chloride or its variants), Na-D (sodium-based compounds), CuCl (Copper Chloride), Sr(OH)₂ (Strontium Hydroxide or its variants), and SrCl₂ (Strontium Chloride or its variants). The determination of the strontium ion in any form—e.g., with-hydroxyl ion or chloride ions, forms a determination that formation or production water exists in the drilling fluid. The various composition components (setting aside outliers like CuCl) contribute to the mixed salinity in the drilling fluid that is analyzed, in-situ, at a drill site during a drilling operation by the tool of the present disclosure.

In at least one aspect, the presence pf strontium in water (in the drilling fluid) is indication of presence of formation water in the drilling fluid. Strontium concentrations tend to increase with amount of formation water present. The present disclosure enables detection of strontium salt characteristics by spectroscopy of the drilling fluid from the bypass line and by determination of an emission in the range of 600-646 nm by a spectrometer, for instance. Further, pulse heating of the formation water in the nano-liter volume provides the atomizer with specific quantity of the drilling fluid to enable fast and accurate spectroscopy and, in turn, fast and accurate reporting of composition components. Emission intensity of the spectra varies with the strontium concentration and an additional detection module may be retrofitted to the flow line to limit intake of the drilling fluid till most of the impurities are eliminated.

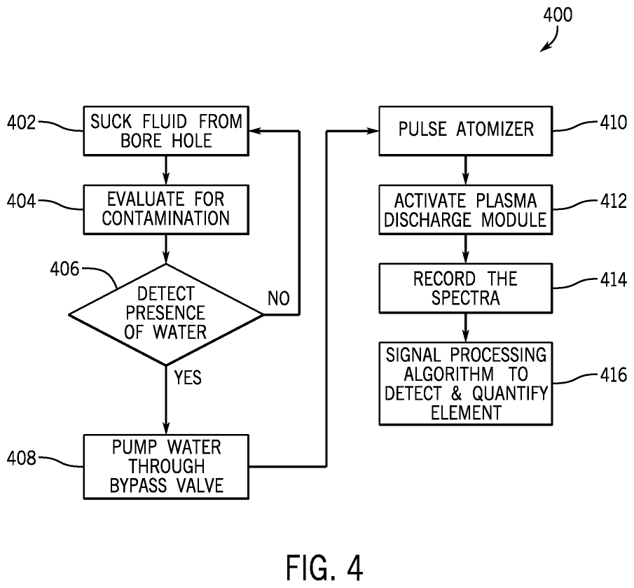

FIG. 4 illustrates example sub-processes 402-416 in a process flow 400 for detection of formation or production water, in accordance with various embodiments. In sub-process 402, drilling fluid is sucked from a bore hole through a bore pipe forming a flow line, such as flow line 102 in FIG. 1. In sub-process 404, the drilling fluid is evaluated for contaminants or impurities as noted in the discussion with reference to FIG. 1. In sub-process 406, a detection of presence of water may be made by an optical module. The optical module is associated with a downstream portion of the flow line and is adapted to provide control signals to activate or deactivate the control valve (such as control valve 154 of FIG. 1B). The water may be applied water or formation water. In sub-process 408, the drilling fluid (sometimes referred to plainly as water but may also include other components (e.g., applied or well oils) and may be free of contaminants) is allowed through or pumped through a bypass line, such as bypass line 104 in FIG. 1. In sub-process 410 a pulse atomizer may be applied to the drilling fluid from the bypass line. A plasma discharge module, such as the detection discharge module 182, may be activated via sub-process 412 to expose the drilling fluid that has been atomized to the plasma. Sub-process 414 records spectra from the plasma exposure to the drilling fluid. This may be performed using a spectrometer as illustrated in the example of FIG. 1B. Sub-process 416 enables a signal processing algorithm to perform correlation of the recorded spectra, for instance to detect and quantify composition components of the spectra.

In an example, the correlation is performed by training a learning system, such as a neural network having multiple layers of nodes (e.g., input layer, output layer, and one or more hidden layers) with known values from the spectra that are associated with previously identified composition components possible in the drilling fluid. A trained neural network is able to adapt to changes in values from the spectra correlating to at least one composition component in the drilling fluid to accurately determine presence of one or more composition components in the drilling fluid. As such, in at least one aspect, the correlation is performed by correlating values in the spectra with known values of a trained learning system to identify one or more composition components in the drilling fluid using at least a processing component. Alternatively or together with the learning system, a signal processing algorithm may be used to perform correlation of the recorded spectra, for instance to detect and quantify composition components of the spectra. The signal processing algorithm may include (principle component analysis or other discriminant analysis for feature engineering) to correlate the recorded spectra with a database of known composition components, for instance.

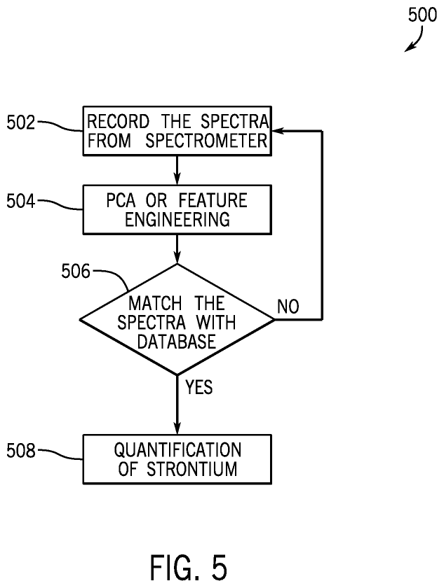

FIG. 5 illustrates example sub-processes 520-508 in a process flow 500 for detection of formation or production water, in accordance with various embodiments. Sub-processes 502-508 may be partly applicable in the process flow 400 of FIG. 4. For instance, sub-process 502 records spectra from a spectrometer, which may be a further description to the sub-process 414 of process flow 400. Sub-process 504 enables PCA (principle component analysis or other discriminant analysis for feature engineering) to correlate the recorded spectra with a database of known composition components, for instance. When a match is determined via sub-process 506 that at least one of the composition components is a strontium (or a beryllium) ion-based composition component, then further determination to quantity or quality, and other aspects for detection, of the formation or production water may be enabled.

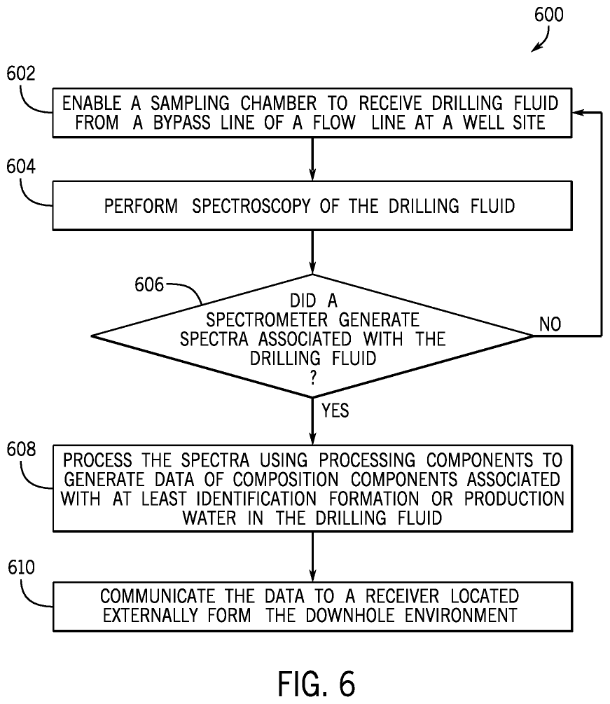

FIG. 6 illustrates an example process flow 600 for a method for detection of formation or production water, in accordance with various embodiments. Process flow 600 includes a sub-process 602 for enabling a sampling chamber to receive drilling fluid from a bypass line of a flow line at a well site. A sub-process 604 of process flow 600 performs spectroscopy on the drilling fluid. A sub-process 606 determines, using a spectrometer, that a spectra was generated from the spectroscopy of the drilling fluid. A sub-process 608 processes the spectra, such as by PCA and correlation, to generate data of composition components associated with at least identification formation or production water in the drilling fluid. A sub-process 610 of the method enables communication of the data associated to a receiver located externally from the downhole environment. While reference is made to drilling fluid in process flow 600, the drilling fluid analyzed by sub-process 602 may refer to a bypassed quantity of the drilling fluid from a flow line that includes the applied fluids and the downhole fluids. Further, the drilling fluid analyzed by sub-process 602 may be atomized prior to presentation in the sample chamber. In this and other aspects of the present disclosure, references made to drilling fluid that are subject to spectral analysis or spectroscopy (e.g., in sub-process 604 and sub-process 412) is generally understood to encompass variations of the present disclosure that may utilize one or more intermediate steps (such as atomizing and/or sampling a part of the drilling fluid) so long as the drilling fluid in the flow line is, in effect, subject to an in-situ determination of its composition components by the overall process performed in the downhole environment. As such, the in-situ determination (and detection) of composition components associated with at least identification formation or production water in the drilling fluid from the bypass line is understood to apply to the drilling fluid in the flow line. For instance, identification of one or more of strontium and beryllium composition compounds in the drilling fluid is an identification of formation or production water in the drilling fluid. The volume or percentage distribution of the composition components may be scaled from the bypass line to the flow line using proportional values of volume and flow rate, for instance.

From all the above, a person of ordinary skill would readily understand that the tool of the present disclosure provides numerous technical and commercial advantages, and can be used in a variety of applications. Various embodiments may be combined or modified based in part on the present disclosure, which is readily understood to support such combination and modifications to achieve the benefits described above.

What is claimed is:

1. A tool (106) for detection of formation or production water in drilling fluid characterized by:
a sampling chamber (158) to receive a bypass line (152) from a flow line (116) at a well site;
at least one spectroscopy component (164) to perform spectroscopy of the drilling fluid bypassed from the flow line into the bypass line;
at least one processing component (172) to process spectra from the spectroscopy of the drilling fluid and to generate data associated with at least identification formation or production water in the drilling fluid; and
a communication module (186) to transmit the data externally from the tool.

2. The tool of claim 1 further characterized by:
an atomizer (184) in the bypass line to provide atomized drilling fluid to the sampling chamber.

3. The tool of claim 1 further characterized by:
a control valve (154) associated with the bypass line; and
an optical module (118) associated with a downstream portion of the flow line and adapted to provide control signals to activate or deactivate the control valve.

4. The tool of claim 3 further characterized by:
the optical module configured to identify water or impurities in the drilling fluid.

5. The tool of claim 3 further characterized by:
the optical module configured to identify water in the drilling fluid and to cause the activation of the control valve.

6. The tool of claim 3 further characterized by:
the optical module configured to identify impurities or contaminants in the drilling fluid and to cause the deactivation of the control valve.

7. The tool of claim 1 further characterized by:
the at least one spectroscopy component configured to confirm presence of one or more of strontium and beryllium composition compounds in the drilling fluid.

8. The tool of claim 1 further characterized by:
the at least one processing component configured to correlate values in the spectra with known values of a trained learning system to identify one or more composition components associated with the formation or production water in the drilling fluid.

9. The tool of claim 1 further characterized by:
a signal processing component (170) within the at least one processing component, the signal processing component configured to correlate at least one signal in the spectra with known signals to identify one or more composition components associated with the formation or production water in the drilling fluid.

10. The tool of claim 1 further characterized by:
a plasma discharge module (182) associated with the sampling chamber to project plasma through the drilling fluid.

11. A method (400; 500; 600) for detection of formation or production water from drilling fluid comprising:
enabling (402-408; 602) a sampling chamber to receive the drilling fluid from a bypass line of a flow line at a well site;
performing (410-412; 604, 606) spectroscopy of the drilling fluid to generate spectra;
processing (414-416; 502-508; 608) the spectra to generate data associated with at least identification formation or production water in the drilling fluid; and
communicating (610) the data to a receiver located externally from the downhole environment.

12. The method of claim 11 further characterized by:
atomizing (410) the drilling fluid in the bypass line to provide atomized drilling fluid to the sampling chamber.

13. The method of claim 11 further characterized by:
providing (404, 406) control signals from an optical module associated with a downstream portion of the flow line to activate or deactivate a control valve associated with the bypass line; and
controlling (408) the drilling fluid in the bypass line using the control valve.

14. The method of claim 13 further characterized by:
identifying (404, 406) water or impurities in the drilling fluid using the optical module; and
preventing or enabling (408) the drilling fluid to flow through the bypass line.

15. The method of claim 13 further characterized by:
identifying (406) water in the drilling fluid using the optical module; and
causing (408) the control valve to enable the drilling fluid to pass through the bypass line.

16. The method of claim 13 further characterized by:
identifying (404) impurities or contaminants in the drilling fluid using the optical module; and
causing (408) the control valve to prevent the drilling fluid to pass through the bypass line.

17. The method of claim 11 further characterized by:
determining (416; 502-506) presence of one or more of strontium and beryllium composition compounds in the drilling fluid using the at least one spectroscopy component; and
determining (508; 608) a well oil percentage projected for the well.

18. The method of claim 11 further characterized by:
correlating values (506) in the spectra with known values of a trained learning system to identify one or more composition components associated with the formation or production water in the drilling fluid using the at least processing component.

19. The method of claim 11 further characterized by:
enabling (416; 608) signal processing of the spectra to correlate at least one signal in the spectra with known signals to identify one or more composition components associated with the formation or production water in the drilling fluid.

20. The method of claim 8 further characterized by:
projecting (412; 604) plasma through the drilling fluid in the sampling chamber to enable the spectroscopy of the drilling fluid.
